(19) United States
(12) Patent Application Publication
(10) Pub. No.: US 2026/0175148 A1
(43) Pub. Date: Jun. 25, 2026

(54) FILTER DEVICE AND FILTER SYSTEM

(71) Applicant: Kioxia Corporation, Tokyo (JP)

(72) Inventors: Hirotoshi YAMAMOTO, Yokkaichi (JP); Hiroshi TOMITA, Yokkaichi (JP); Hiroshi FUJITA, Mie (JP); Toshiyuki MURANAKA, Yokkaichi (JP); Yusuke OSHIMA, Yokkaichi (JP)

(21) Appl. No.: 19/335,171

(22) Filed: Sep. 22, 2025

(30) Foreign Application Priority Data
Dec. 19, 2024 (JP) 2024-223915

(51) Int. Cl. B01D 29/17; B01D 35/14

(52) U.S. Cl. CPC B01D 29/17; B01D 35/14; B01D 2221/14

(57) ABSTRACT

A filter device includes a housing having a first port and a second port; a filter provided in the housing and having a first through-hole that has a first opening and a second opening, and extends in a longitudinal direction of the housing; and a support unit having (i) a first portion that has a second through-hole having a third opening connected to the second port and a fourth opening provided in the first through-hole, and (ii) a second portion connected to the first portion in a vicinity of the third opening and supporting the filter, the first portion of the support unit extending in the longitudinal direction.

### CROSS-REFERENCE TO RELATED APPLICATION

This application is based upon and claims the benefit of priority from Japanese Patent Application No. 2024-223915, filed Dec. 19, 2024, the entire contents of which are incorporated herein by reference.

### FIELD

Embodiments described herein relate generally to a filter device and a filter system.

### BACKGROUND

In a manufacturing process of a semiconductor device, various liquids (chemical solutions) are used. The liquid used in a manufacturing process of the semiconductor device includes liquid-in defects such as bubbles, metal particles, and other particles. The presence of such liquid-in defects causes a defective shape of the device when the semiconductor device is finely processed. Therefore, the yield of the semiconductor device is reduced. Therefore, before the liquid is liquid-delivered to a manufacturing apparatus of the semiconductor device, a filter for the liquid is used to remove the liquid-in defects.

### DESCRIPTION OF THE DRAWINGS

FIG. 1 is a schematic diagram of a filter system according to an embodiment.

FIGS. 2A to 2C are schematic diagrams of a filter and a support unit according to the embodiment.

FIGS. 3A to 3D are schematic diagrams showing a usage aspect of a housing, the filter, and the support unit according to the embodiment.

FIG. 4 is a schematic diagram showing an example of a multi-housing filter according to the embodiment.

FIGS. 5A and 5B are schematic diagrams of an evaluation device according to the embodiment.

FIG. 6 is an example of a liquid evaluation including the liquid-in defect, which is performed by using a defect detection cell according to the embodiment.

FIG. 7 is another example of the liquid evaluation including liquid-in defects, which is performed by using a defect detection cell according to the embodiment.

FIG. 8 is a flowchart of a usage method of a filter system according to a first aspect of the embodiment.

FIG. 9 is a flowchart of a usage method of a filter system according to a second aspect of the embodiment.

FIG. 10 is a schematic diagram of an inside of a filter device according to a comparative example.

FIG. 11 is a schematic diagram showing an operation and an effect of the filter device according to the embodiment.

### DETAILED DESCRIPTION

Embodiments provide a filter device and a filter system in which air is less likely to be trapped inside.

In general, according to one embodiment, a filter device includes a housing having a first port and a second port; a filter provided in the housing and having a first through-hole that has a first opening and a second opening, and extends in a longitudinal direction of the housing; and a support unit having (i) a first portion that has a second through-hole having a third opening connected to the second port and a fourth opening provided in the first through-hole, and (ii) a second portion connected to the first portion in a vicinity of the third opening and supporting the filter, the first portion of the support unit extending in the longitudinal direction.

Hereinafter, embodiments will be described with reference to the drawings. In the drawings, the same or similar portions are designated by the same or similar reference numerals.

In the present specification, in order to indicate a positional relationship of components and the like, an upper direction of a drawing is described as “up”, and a lower direction of the drawing is described as “down”. In the present specification, the concepts of “up” and “down” are not necessarily terms indicating a relationship with the direction of gravity.

In the present specification, an X-axis, a Y-axis that intersects the X-axis perpendicularly, and a Z-axis that intersects the X-axis and the Y-axis perpendicularly are defined. The Z-axis is a direction opposite to a vertical direction.

### EMBODIMENTS

A filter device of an embodiment includes a housing having a first port and a second port; a filter provided in the housing and having a first through-hole that has a first opening and a second opening, and extends in a predetermined direction; and a support unit having a first portion that has a second through-hole having a third opening connected to the second port and a fourth opening provided in the first through-hole, and extending in the predetermined direction, and a second portion that is connected to the first portion in a vicinity of the third opening and supports the filter.

In addition, the filter device of the embodiment includes a filter having a first through-hole that has a first opening and a second opening, and extends in a first direction; and a support unit that has a first portion having a second through-hole that has a third opening and a fourth opening, and extends in a second direction, and a second portion that is connected to the vicinity of the third opening to support the filter.

A filter system of an embodiment includes a storage tank storing a liquid including a liquid-in defect; the filter device; a liquid delivery pump that is connected to the storage tank and the first port of the filter device, and liquid-delivers the liquid to the filter device from the storage tank; and an evaluation device that is connected to the second port of the filter device and the storage tank, and measures the liquid-in defect.

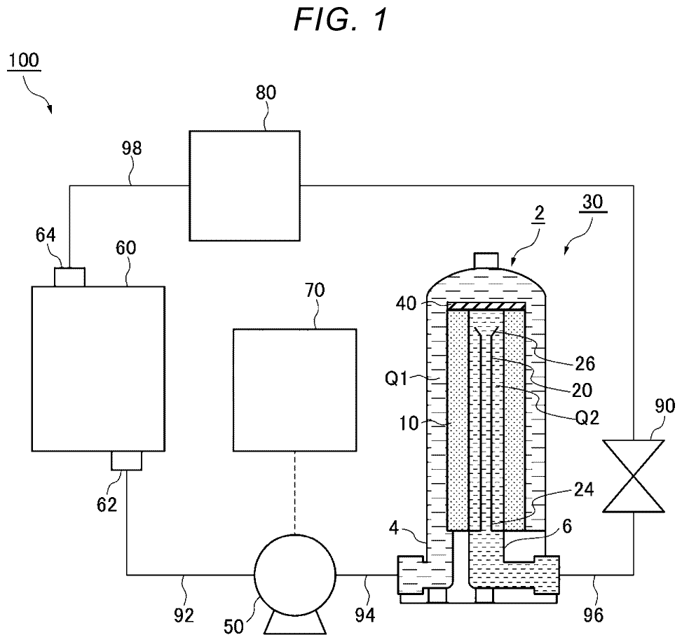

FIG. 1 is a schematic diagram of a filter system 100 of an embodiment.

The filter system 100 includes a storage tank 60, a first pipe 92, a liquid delivery pump 50, a pump control unit 70, a second pipe 94, a filter device 30, a third pipe 96, a valve 90, an evaluation device (defect detection cell, liquid-in defect evaluation device) 80, and a fourth pipe 98.

The filter device 30 has a housing 2, a filter 10, and a support unit 20. The housing 2 has a first port (inlet, primary side port) 4 and a second port (outlet, secondary side port) 6. The filter 10 and the support unit 20 will be described below.

The storage tank 60 is a container for storing a liquid Q to be filtered by the filter device 30.

The liquid Q is, for example, a chemical solution used in a semiconductor manufacturing process. It is preferable that the liquid Q is, for example, a chemical solution containing a quaternary amine, a chemical solution containing a quaternary amine and a surfactant, or a chemical solution containing water and a surfactant. However, the type of the liquid Q is not particularly limited to the above.

In addition, the chemical solution containing the quaternary amine is preferably an aqueous solution of tetramethylammonium hydroxide (TMAH) or an aqueous solution of trimethyl-2-hydroxyethylammonium hydroxide.

The liquid Q contains a bubble B, a first particle M containing a metal, and a second particle P different from the bubble B and the first particle M. Here, the first particle M is a particle of silver, gold, iron oxide hydroxide, chromium oxide, or the like. In addition, here, the second particle P is, for example, a particle of a carbon material, silica (quartz), or a fluororesin.

In the present specification, the bubble B, the first particle M, and the second particle P are collectively referred to as a liquid-in defect.

The storage tank 60 has an outlet 62 and an inlet 64.

The first pipe 92 connects the outlet 62 and the liquid delivery pump 50. The second pipe 94 connects the liquid delivery pump 50 and the first port 4 of the filter device 30. The third pipe 96 connects the second port 6 of the filter device 30 and the evaluation device 80. The fourth pipe 98 connects the evaluation device 80 and the inlet 64.

The liquid Q is supplied from the first port 4 to the filter device 30 via the first pipe 92 and the second pipe 94 from the outlet 62 by using the liquid delivery pump 50. The liquid Q is filtered by the filter device 30. The filtered liquid Q is discharged from the second port 6. The discharged liquid Q is supplied to the evaluation device 80 via the third pipe 96. In the evaluation device 80, the liquid-in defect of the liquid Q is evaluated. The liquid Q, which is evaluated for the liquid-in defect, is returned to the storage tank 60 from the inlet 64 via the fourth pipe 98.

A flow rate in the pipe is adjusted, for example, by the pump control unit 70 connected to the liquid delivery pump 50 and the valve 90 provided in the third pipe 96.

It is also possible to provide other pipes for sharing the filtered liquid Q with other semiconductor manufacturing apparatuses or the like.

The pump control unit 70 is, for example, an electronic circuit. The pump control unit 70 is, for example, a computer configured with a combination of hardware such as an arithmetic circuit and software such as a program.

The valve 90 is, for example, a needle valve or a ball valve, but is not particularly limited thereto.

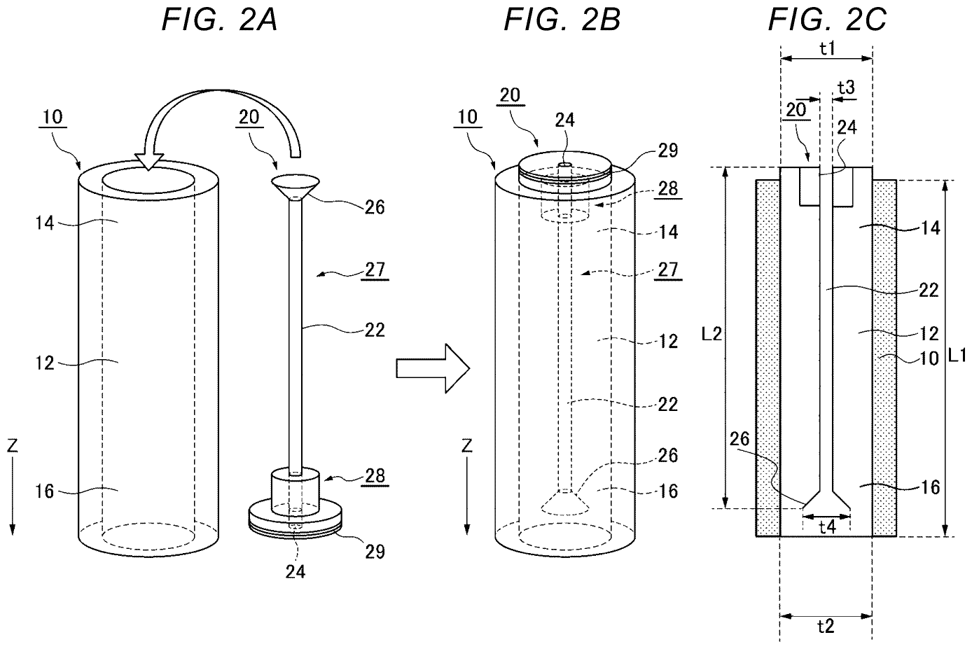

FIGS. 2A to 2C are schematic diagrams of the filter 10 and the support unit 20 according to the embodiment. In FIG. 2A, each of the filter 10 and the support unit 20 is shown. FIGS. 2B and 2C show an aspect in which the support unit 20 is accommodated in a first through-hole 12 of the filter 10 inside the housing 2.

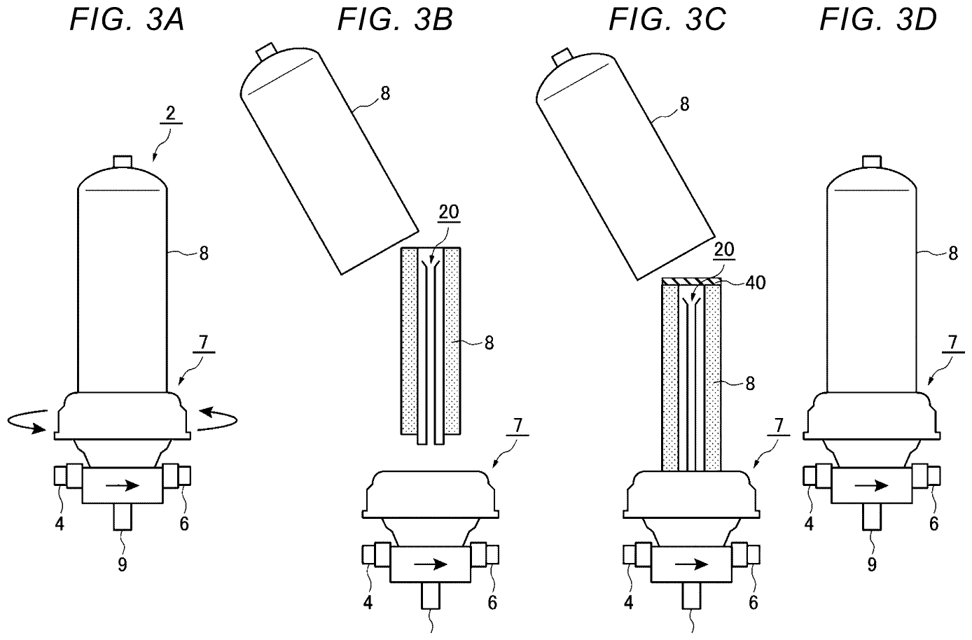

FIGS. 3A to 3D are schematic diagrams showing a usage aspect of the housing 2, the filter 10, and the support unit 20 according to the embodiment.

The filter 10 is provided in the housing 2. The filter 10 has, for example, a cylindrical shape extending in a predetermined direction. The filter 10 has the first through-hole 12 extending in a predetermined direction. In FIGS. 2A to 2C, the predetermined direction is shown as being parallel to the Z direction. In FIGS. 2A to 2C, one opening of the first through-hole 12 is a first opening 14. In addition, the other opening of the first through-hole 12 is a second opening 16. A material of the filter 10 is, for example, polytetrafluoroethylene (PTFE), polyvinylidene fluoride (PVDF), polyethersulfone (PES), nylon, or ceramics. However, the material of the filter 10 is not limited to these.

The liquid Q is supplied from the first port 4 of the housing 2 to the inside of the housing 2. Inside the housing 2, the liquid Q is filtered from the outside of the filter 10 into the first through-hole 12. The filtered liquid Q enters a second through-hole 22 from a fourth opening 26 of the support unit 20. The liquid Q is discharged to the outside of the filter device 30 from the second port 6 connected to a third opening 24. In the embodiment, the liquid Q before being filtered by the filter 10 may be referred to as a liquid Q1, and the liquid Q after being filtered by the filter 10 may be referred to as a liquid Q2.

The support unit 20 has a first portion 27 and a second portion 28.

The first portion 27 has a tubular shape having the second through-hole 22. One opening of the first portion 27 is the third opening 24. The other opening of the first portion 27 is the fourth opening 26.

The second portion 28 is connected to the vicinity of the third opening 24. For example, a groove (not shown) for providing an O-ring 29 is provided in the second portion 28. The third opening 24 is connected to the second port 6 by using the second portion 28 and the O-ring 29 so that the liquid Q filtered by the filter 10 does not leak. In addition, the first opening 14 of the filter 10 is fixed and supported, for example, by being fitted to the second portion 28. The second opening 16 of the filter 10 may be fixed and supported by the second portion 28.

Although the O-ring 29 is used in the embodiment, another sealing material such as a packing may be used instead of the O-ring 29.

As shown in FIG. 2B, the fourth opening 26 is provided in the first through-hole 12 of the filter 10. The third opening 24 is provided outside the first through-hole 12 of the filter 10 in FIG. 2B. However, the third opening 24 may be provided inside the first through-hole 12.

It is preferable that the fourth opening 26 has, for example, a flare shape (flare) as shown in FIGS. 1 to 3D. In this case, an inner diameter of the fourth opening 26 is larger than an inner diameter of the third opening 24.

A partition plate 40 is provided in the filter 10 on a second opening 16 side. The partition plate 40 is a mechanism for preventing the liquid Q from entering the first through-hole 12 from the outside of the filter 10 without being filtered by the filter 10. The mechanism for preventing the liquid Q from entering the first through-hole 12 from the outside of the filter 10 without being filtered by the filter 10 is not limited to the partition plate 40.

It is preferable that the fourth opening 26 does not come into contact with the filter 10.

It is preferable that an inner diameter t4 of the fourth opening 26 is larger than an inner diameter t3 of the third opening 24.

It is preferable that a length L2 of the second through-hole 22 is ½ or more of a length L1 of the first through-hole 12.

On the other hand, the length L2 of the second through-hole 22 is, for example, the length L1 or less of the first through-hole 12.

It is preferable that the inner diameter t1 of the first opening 14 or the inner diameter t2 of the second opening 16 is 1/10 or more and ½ or less of the inner diameter t3 of the third opening 24.

It is preferable that the inner diameter t1 of the first opening 14 or the inner diameter t2 of the second opening 16 is ⅕ or more and ⅘ or less of the inner diameter t4 of the fourth opening 26.

As shown in FIG. 3A, the housing 2 has a base portion 7 and a cover portion 8 provided on the base portion 7. The base portion 7 is provided with the first port 4 and the second port 6. For example, the third port 9 is provided in a lower portion of the base portion 7. The third port 9 is used, for example, as a drain port for draining the liquid Q from the housing 2. The cover portion 8 is connected to an upper portion of the base portion 7 by, for example, a screw mechanism (not shown) or the like.

The aspect of the housing 2 is not limited to the above.

In a case where the filter 10 and the support unit 20 are disposed in the housing 2, the cover portion 8 is detached from the base portion 7 (FIG. 3B). Next, the filter 10 and the support unit 20 are disposed on the base portion 7 such that the fourth opening 26 of the support unit 20 is connected to the second port 6. In addition, the partition plate 40 is attached to the upper portion of the filter 10 (FIG. 3C). Next, the cover portion 8 is fixed to the base portion 7, for example, by screwing (FIG. 3D).

In addition, the filter system 100 may have a plurality of filter devices 30. The liquid Q may be filtered by the plurality of filter devices 30.

For example, the filter devices 30 may be connected in series to each other. For example, in a case where the filter system 100 has a filter device 30a and a filter device 30b, the second port 6 of the filter device 30a and the first port 4 of the filter device 30b may be connected to each other using a pipe, for example.

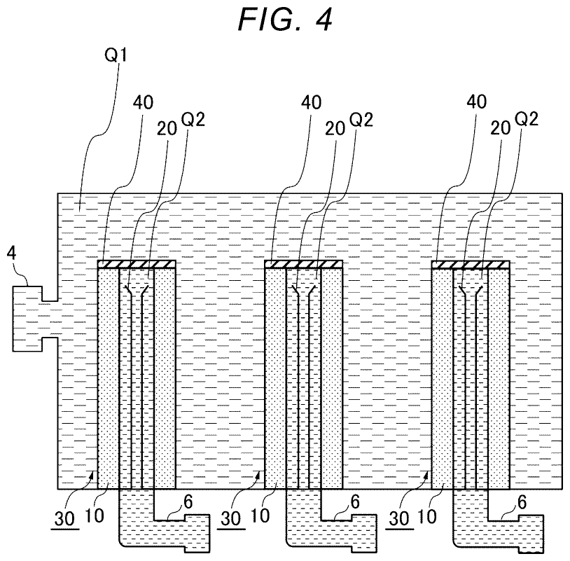

In addition, for example, the filter devices 30 may be connected in parallel to each other. FIG. 4 is a schematic cross-sectional diagram showing a multi-housing filter 110 in which the filter devices 30 are connected in parallel to each other. A housing 200 has, for example, one first port 4 and a plurality of second ports 6. A plurality of filters 10, the support units 20, and the partition plates 40 are provided in the housing 200. The liquid Q is filtered by the plurality of filters 10, and is discharged from the plurality of second ports 6 by passing through the support units 20 inside each of the filters 10.

Here, a structure of the evaluation device 80 will be described. The evaluation device 80 is, for example, a test device that acquires a particle diameter (geometric diameter) of the liquid-in defect by a flow particle tracking (FPT) method.

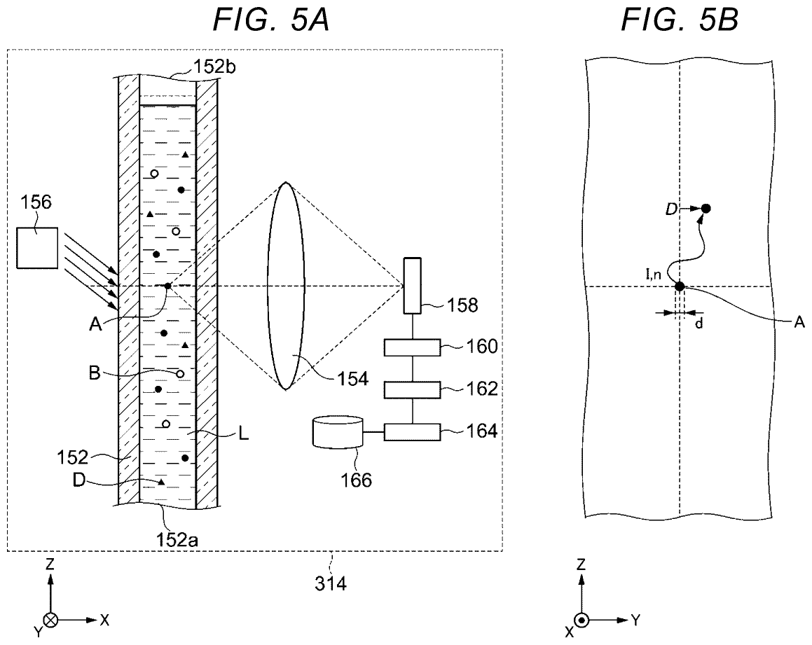

FIGS. 5A and 5B are schematic diagrams of a defect detection cell (evaluation unit) 314 used in the evaluation device 80 and acquires the particle diameter of the liquid-in defect by the FPT method. FIG. 5A is a schematic diagram of the defect detection cell 314 according to the embodiment.

A column 152 is a transparent container capable of accommodating a solvent. A flow of the solvent in the column 152 is a laminar flow flowing in the Z-axis direction. The column 152 is formed of, for example, synthetic quartz or sapphire. The solvent flows from a column inlet 152a of the column 152 to a column outlet 152b.

An irradiation unit (light source) 156 irradiates the solvent in the column 152, for example, with irradiation light such as laser light. For example, when the solvent flows in the Z-axis direction, the irradiation unit 156 irradiates the solvent with the irradiation light in the X-axis direction. The irradiation direction of the irradiation light is not limited to the X-axis direction.

An image capturing unit 158 has a charge coupled device (CCD) sensor, a complementary metal oxide semiconductor (CMOS) sensor, or the like (not shown). The image capturing unit 158 images the solvent in the column 152 using a lens 154 or the like. A video image of a scattered light emitted from the liquid-in defect is acquired. FIG. 5B is an example of a schematic diagram of a video image of metal particles A acquired by the image capturing unit 158. An analysis unit 160 obtains a diffusion coefficient D of the bubble B, the metal particles A, and the particles D different from the bubble B and the metal particles from the video image. Here, the metal particle A is an example of the first particle. Further, the particle D is an example of the second particle. The particle D is, for example, a particle of a carbon material, silica (quartz), or a fluororesin.

In a case where the liquid-in defect causes the solvent to undergo Brownian motion, the diffusion coefficient D of the liquid-in defect can be obtained from the video image of the scattered light of the liquid-in defect. The diffusion coefficient D and a defect diameter d of the liquid-in defect are related by the following relational equation.

$$\begin{matrix}Equation 1 & \\ D = \frac{{k}_{B} T}{3 πη d} & ( 1 )\end{matrix}$$

In Equation (1), D is the diffusion coefficient of the liquid-in defect, KB is a Boltzmann constant, T is an absolute temperature, n is a viscosity (viscosity coefficient) of the solvent, and d is the defect diameter of the liquid-in defect. A calculation unit 162 can obtain the defect diameter d of the liquid-in defect from the diffusion coefficient D by using Equation (1).

In addition, a refractive index of the liquid-in defect can be obtained from the following equation.

$$\begin{matrix}Equation 2 & \\ I ∝ {I}_{0} \frac{c}{2 {r}^{2}} {( \frac{2 π}{λ} )}^{4} {( \frac{d}{2} )}^{6} {\vert \frac{{m}^{2} - 1}{{m}^{2} + 2} \vert}^{2} & ( 2 )\end{matrix}$$

In Equation (2), I is an intensity of the scattered light, I₀ is an intensity of the incident light, c is the number concentration of the liquid-in defect, r is a distance from the liquid-in defect to the image capturing unit 158, λ is a wavelength of the incident light, d is the particle diameter of the liquid-in defect, and m is a relative refractive index of the liquid-in defect with respect to the solvent. The relative refractive index m is obtained by dividing the refractive index n of the defect by the refractive index no of the solvent (m=n/n0). When the refractive index n0 of a first mixture or a second mixture is known, the calculation unit 162 can obtain the refractive index n of the liquid-in defect by using Equation (2).

A determination unit 164 determines whether the liquid-in defect is the bubble, the metal particle A, or the particle D, by using the refractive index n calculated by the calculation unit 162. For example, a database 166 in which the refractive index of a known substance is stored is connected to the determination unit 164. For example, in the determination, the determination unit 164 refers to the refractive index of the known substance.

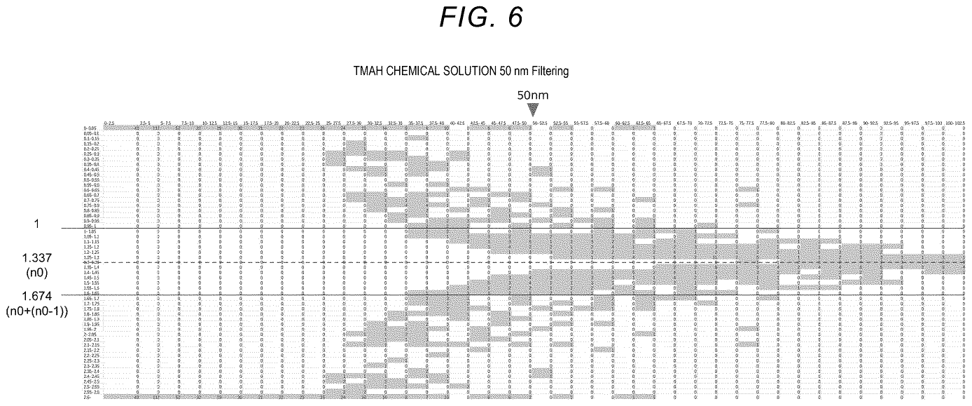

FIG. 6 is an example of a liquid evaluation including the liquid-in defect, which is performed by using the defect detection cell (evaluation unit) 314 according to the embodiment. In a graph shown in FIG. 6, a horizontal axis is the defect diameter d of the liquid-in defect and a vertical axis is the refractive index n of the liquid-in defect calculated by the calculation unit 162.

In FIG. 6, a distribution similar to each other is shown above and below with the refractive index no of the solvent as a center. In other words, the calculation unit 162 obtains two refractive indices n with the refractive index no of the solvent as a center for the same defect diameter d. This is because the equation (2) is a quadratic equation of the relative refractive index m. Therefore, the evaluation method according to the embodiment is a semi-quantitative method in which the relative refractive index m obtained by Equation (2) is compared with known refractive index data.

Specifically, when the refractive index of the solvent of the measurement target is n0, the determination unit 164 preferably determines the liquid-in defect as the metal particles in a case where the refractive index n is greater than n0+(n0−1) or the refractive index n is less than 1. Further, when the refractive index of the solvent of the measurement target is n0, the determination unit 164 preferably determines the liquid-in defect as the bubble or the particle D in a case where the refractive index n is 1 or more or n0+ (n0−1) or less. In other words, in a case where the refractive index n is calculated to be within a range of a difference between the refractive index n0 of the solvent and the refractive index 1 of the bubble, with the refractive index n0 as a center, the liquid-in defect is determined to be the particles D or the bubble, and in a case where the refractive index n is calculated to be outside the range of the difference between the refractive index n0 of the solvent and the refractive index 1 of the bubble, with the refractive index n0 as a center, the liquid-in defect is determined to be the metal particles A. That is, the determination unit 164 determines that the liquid-in defect is the metal particles A in a case where the refractive index n satisfies “n<1” or “n0+(n0−1)<n”, and determines that the liquid-in defect is the particles D or the bubble in a case where the refractive index n satisfies “1≤n≤n0+(n0−1)” when the refractive index of the solvent of the measurement target is n0. The refractive index n0 of the solvent of the measurement target is, for example, 1.2 to 1.5, but is not limited thereto.

The database 166 may not be provided. The determination unit 164 may simply use the size relationship between the refractive indices described above to distinguish between the bubble and the metal particles.

The database 166 is, for example, a storage device such as a semiconductor memory or a hard disk. The analysis unit 160, the calculation unit 162, and the determination unit 164 are, for example, electronic circuits. The analysis unit 160, the calculation unit 162, and the determination unit 164 are, for example, a computer configured with a combination of hardware such as an arithmetic circuit and software such as a program.

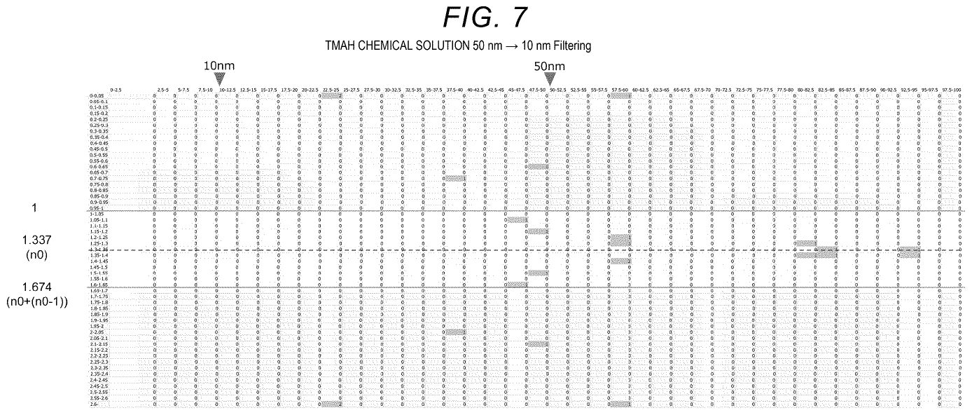

FIGS. 6 and 7 are more specific examples of the evaluation of the liquid including the liquid-in defect.

When the sum of the number of defect detections in a range of the refractive index n>n0+(n0−1) is a(1) and the sum of the number of defect detections in a range of the refractive index n<1 is a(2), the number of the metal particles A in the liquid can be expressed by the following equation.

$$( a ( 1 ) + a ( 2 ) ) / 2 = the number of metal particles A \qquad ( 3 )$$

Further, when the sum of the measurement values in the range of n0+(n0−1)≥n≥1 of the refractive index n is a(3), the number of the bubbles B or the particles D in the liquid can be expressed by the following equation.

$$a ( 3 ) / 2 = the number of the bubbles B or the particles D \qquad ( 4 )$$

Further, by substituting a(1), a(2), and a(3) at a certain defect diameter d into the above equation, it is also possible to obtain the number of metal particles A at the defect diameter d and the number of bubbles B or particles D.

In both equations, the sum of the measurement values in each type of defect is divided by 2, which is because the refractive index n obtained from Equation (2) has two solutions for each detected defect.

A state of a distribution of the defects detected from the defect diameter d and the refractive index n calculated by the calculation unit 162 is shown in FIGS. 6 and 7. FIG. 6 shows a state of a distribution of defects in TMAH after passing through a 50 nm pore size filter. FIG. 7 shows a state of a distribution of defects in TMAH after passing through the 50 nm pore size filter and further passing through a 10 nm pore size filter. The horizontal axis is the defect diameter d, and the vertical axis is the refractive index n.

In FIGS. 6 and 7, the number of defect detections in each region is shown by dividing the defect diameter d (horizontal axis) into 2.5 nm in the range of 0 to 100 nm and dividing the refractive index n (vertical axis) into 0.05 in the range of 0 to 2.6. A region in which one or more defects are detected in the distribution diagram is colored with the most concentrated color.

For example, it is considered to obtain the number of metal particles A or the number of bubbles B and the particles D from FIGS. 6 and 7. In this case, since the refractive index of TMAH is 1.337, the number of metal particles A is a value obtained by dividing the sum of the number of defect detections in the range of the refractive index n>1.674 and n<1 by 2. The number of the bubbles B or the particles D is a value obtained by dividing the sum of the number of defect detections in the range of 1.674≥n≥1 by 2.

From FIG. 6, in the case of the 50 nm filter, one or more defects are detected in the region where the defect diameter d is 30 to 50 nm. In particular, the number of defect detections is large in the range where the refractive index is n>1.674 and n<1. From this, it can be read the state where many metal particles, bubbles, and other particles are drained. On the other hand, from FIG. 7, in the case of the 10 nm filter, the number of defect detections in the range where the defect diameter d is 30 to 50 nm and the refractive index is n>1.674 and n<1 is small. From this, it can be read the state where the metal particles are reduced. As described above, it can be seen that the removal performance of the filter can be more appropriately evaluated by the FPT measurement for obtaining the correct geometric diameter from the diffusion coefficient D in the evaluation method of the embodiment.

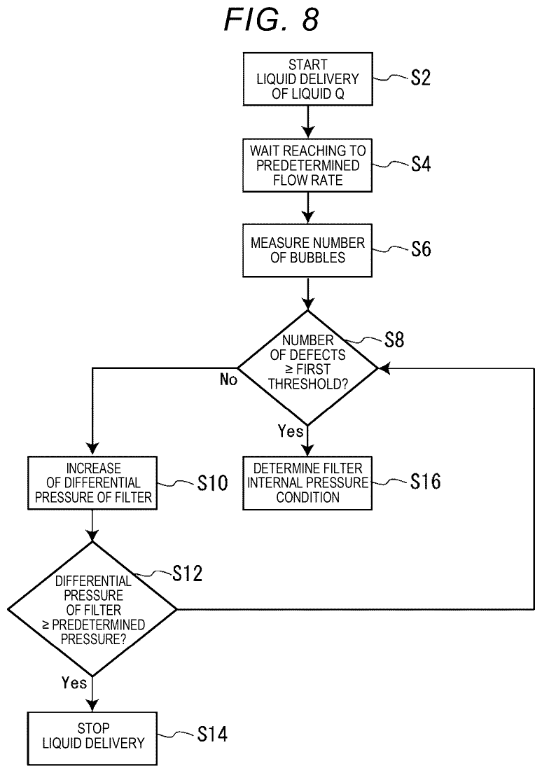

FIG. 8 is a flowchart of a usage method of a filter system according to a first aspect of the embodiment.

First, the liquid Q is liquid-delivered from the storage tank 60 to the filter device 30 by using the liquid delivery pump 50 (S2). Next, the flow rate of the liquid Q in the pipe is waited until a predetermined flow rate is reached (S4). The liquid Q is repeatedly filtered by the filter 10 in the filter device 30. The flow rate of the liquid Q in the pipe can be measured, for example, by using a flow meter or the like provided in the pipe (not shown in FIG. 1).

Next, the number of bubbles in the liquid Q is measured using the evaluation device 80 (S6). For example, in a situation where it can be assumed that the particles D other than the metal do not exist at all, when the refractive index n satisfies “1≤n≤n0+(n0−1)”, the liquid-in defect can be determined as the bubble.

Next, it is determined whether the number of bubbles in the measured liquid Q is equal to or greater than a predetermined first threshold, for example, by using the determination unit 164 (S8). When the number of the bubbles in the liquid Q is equal to or greater than the first threshold, a differential pressure of the filter 10 is increased (S10). Specifically, the flow rate of the liquid Q can be increased by using the liquid delivery pump 50 and the pump control unit 70, and thus the differential pressure of the filter 10 can be increased. In addition, the differential pressure of the filter 10 can be increased by reducing an opening degree of the valve 90 (operating the valve 90 in a closing direction).

In the embodiment, the threshold including the first threshold can be stored, for example, in a database such as the database 166.

Next, it is determined whether the differential pressure of the filter 10 is equal to or greater than a predetermined differential pressure (S12). This determination can be performed by, for example, the determination unit 164 using the value of the flow rate measured by the flow meter provided in the pipe. For example, when the flow rate of the liquid Q is equal to or greater than the predetermined flow rate, it can be assumed that the differential pressure of the filter 10 is equal to or greater than the predetermined differential pressure. When the differential pressure of the filter 10 is equal to or greater than the predetermined differential pressure, the liquid delivery is stopped (S14). When the differential pressure of the filter 10 is less than the predetermined differential pressure, the processing returns to S8, and it is determined whether the number of bubbles in the measured liquid Q is equal to or greater than the predetermined first threshold. The predetermined differential pressure can be stored, for example, in a database such as the database 166.

On the other hand, when the number of bubbles in the measured liquid Q is less than the predetermined first threshold, the liquid delivery is continued, and a filter internal pressure condition is determined (S16).

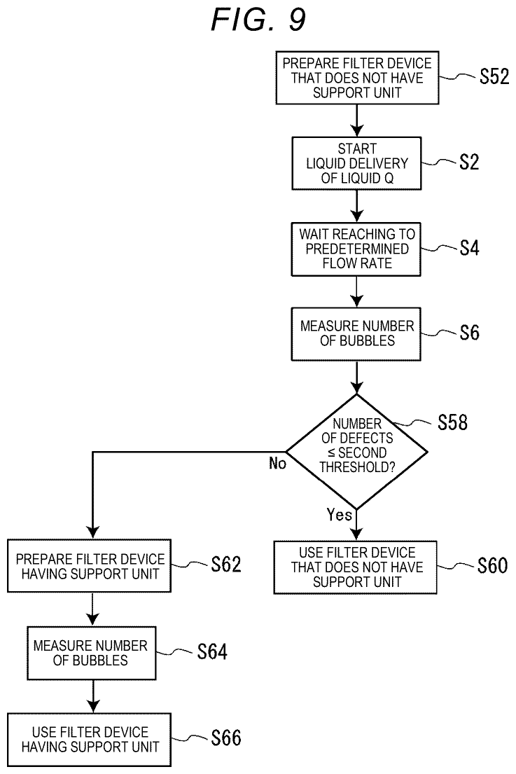

FIG. 9 is a flowchart of a usage method of the filter system 100 according to a second aspect of the embodiment.

Here, the filter device 30 that does not have the support unit 20 is prepared (S52).

Next, as in the first aspect, the liquid Q is liquid-delivered from the storage tank 60 to the filter device 30 by using the liquid delivery pump 50 (S2). Next, the flow rate of the liquid Q in the pipe is waited until a predetermined flow rate is reached (S4). Next, the number of bubbles in the liquid Q is measured using the evaluation device 80 (S6).

Next, when the number of bubbles in the liquid Q is equal to or less than a second threshold, the liquid Q is filtered using the filter device 30 that does not have the support unit 20 (S60).

On the other hand, when the number of bubbles in the liquid Q is greater than the second threshold, the filter device 30 having the support unit 20 is prepared (S62). Then, the number of bubbles is measured by the evaluation device 80 (S64), and then the filter device 30 having the support unit 20 is used (S66).

The usage method of the filter system 100 according to the second aspect is preferably used to determine whether the liquid Q is a preferable liquid to be used in the filter device 30 according to the embodiment. In other words, it is not necessary to use the support unit 20 as long as the liquid Q is a liquid that is difficult to foam. On the other hand, when the liquid Q is a liquid that is easily foamed, it is preferable to use the support unit 20.

Next, an operation and an effect of the filter device 30 according to the embodiment will be described.

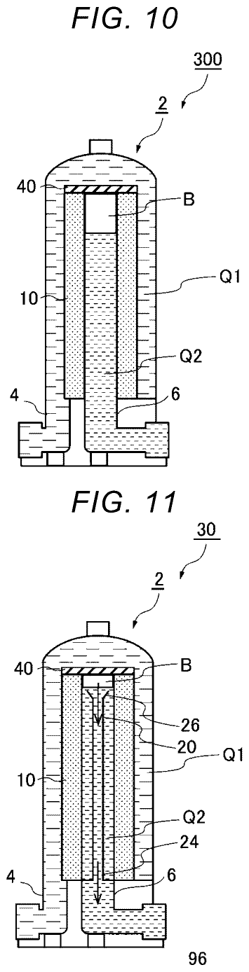

FIG. 10 is a schematic diagram of an inside of a filter device 300 according to the comparative example. The filter device 300 does not have the support unit 20. In this case, there is a problem in that the bubble B inside the liquid Q filtered by the filter 10 is trapped at the upper portion of the first through-hole 12 and the bubble is generated from the gas-liquid interface.

In order to remove the bubble, it is considered to provide an opening (vent) that allows the bubble to be drained (air to be drained) from the secondary side of the filter. However, there is a problem that the opening (vent) cannot be provided depending on the shapes of the pipes of the other devices. In particular, in the case of the multi-housing filter, there is a problem that it is difficult to discharge the bubble to the outside of the housing from the first through-hole 12 of each filter 10.

FIG. 11 is a schematic diagram showing the operation and the effect of the filter device of the embodiment.

Inside the first through-hole 12, a pressure difference is generated between the outside of the support unit 20 and the inside of the support unit 20 (inside the second through-hole 22). Specifically, the inner pressure of the inside of the support unit 20 (inside the second through-hole 22) is higher than that of the outside of the support unit 20. Therefore, the internal pressure difference is generated between the outside and the inside of the support unit 20. The air trapped at the upper portion of the first through-hole 12 can be discharged to the third opening 24 from the fourth opening 26 by using the internal pressure difference. As a result, it is possible to provide a filter device and a filter system in which air is less likely to be trapped inside.

It is preferable that an inner diameter t4 of the fourth opening 26 is larger than an inner diameter t3 of the third opening 24. This is to make it easier for the air to enter the second through-hole 22.

It is preferable that the fourth opening 26 does not come into contact with the filter 10. In a case where the fourth opening 26 comes into contact with the filter 10, the movement of the air in the first through-hole 12 is hindered, and thus it is difficult to smoothly discharge the air.

It is preferable that the length L2 of the second through-hole 22 is ½ or more of the length L1 of the first through-hole 12. The reason is that a large amount of air is trapped in the second through-hole 22, in a case where the length L2 of the second through-hole 22 is less than ½ of the length L1 of the first through-hole 12.

In order to appropriately provide the internal pressure difference and discharge air well, it is preferable that the inner diameter t1 of the first opening 14 or the inner diameter t2 of the second opening 16 is 1/10 or more and ½ or less of the inner diameter t3 of the third opening 24. In addition, it is preferable that the inner diameter t1 of the first opening 14 or the inner diameter t2 of the second opening 16 is ⅕ or more and ⅘ or less of the inner diameter t4 of the fourth opening 26.

In a case where the liquid Q is the chemical solution containing the quaternary amine, the chemical solution containing the quaternary amine and the surfactant, or the chemical solution containing water and the surfactant, the liquid Q is easily foamed, and thus, the air can be preferably discharged by the filter device and the filter system of the embodiment.

In addition, in a case where the chemical solution containing the quaternary amine is an aqueous solution of tetramethylammonium hydroxide (TMAH) or an aqueous solution of trimethyl-2-hydroxyethylammonium hydroxide, the chemical solution is particularly likely to foam, and thus, the air can be preferably discharged by the filter device and the filter system of the embodiment.

According to the filter device and the filter system of the embodiment, it is possible to provide a filter device and a filter system in which air is less likely to be trapped inside.

Although some embodiments and examples of the present disclosure are described, these embodiments and examples are presented as examples and are not intended to limit the scope of the disclosure. These novel embodiments can be implemented in various other aspects, and various omissions, exchanges, and changes can be made without departing from the gist of the disclosure. These embodiments and modifications thereof are provided in the scope and gist of the disclosure, and are also provided in the scope of the disclosure described in the claims and the equivalent scope thereof.

While certain embodiments have been described, these embodiments have been presented by way of example only, and are not intended to limit the scope of the disclosure. Indeed, the novel embodiments described herein may be embodied in a variety of other forms; furthermore, various omissions, substitutions and changes in the form of the embodiments described herein may be made without departing from the spirit of the disclosure. The accompanying claims and their equivalents are intended to cover such forms or modifications as would fall within the scope and spirit of the disclosure.

What is claimed is:

1. A filter device including:
a housing having a first port and a second port;
a filter provided in the housing and having a first through-hole that has a first opening and a second opening, and extends in a longitudinal direction of the housing; and
a support unit having (i) a first portion that has a second through-hole having a third opening connected to the second port and a fourth opening provided in the first through-hole, and (ii) a second portion connected to the first portion in a vicinity of the third opening and supporting the filter, the first portion of the support unit extending in the longitudinal direction.

2. The filter device according to claim 1, wherein an inner diameter of the fourth opening is larger than an inner diameter of the third opening.

3. The filter device according to claim 1, wherein the fourth opening is not contact with the filter.

4. The filter device according to claim 1, wherein a length of the second through-hole is equal to or longer than ½ of a length of the first through-hole.

5. The filter device according to claim 1, wherein an inner diameter of the first opening or an inner diameter of the second opening is equal to or greater than 1/10 of an inner diameter of the third opening and equal to or less than ½ of the inner diameter of the third opening.

6. The filter device according to claim 1, wherein an inner diameter of the first opening or an inner diameter of the second opening is equal to or greater than ⅕ of an inner diameter of the fourth opening and equal to or less than ⅘ of the inner diameter of the fourth opening.

7. The filter device according to claim 1, wherein the filter is configured to filter a liquid, the liquid includes a chemical solution containing a quaternary amine, a chemical solution containing a quaternary amine and a surfactant, or a chemical solution containing water and a surfactant.

8. The filter device according to claim 7, wherein the chemical solution containing the quaternary amine is an aqueous solution of tetramethylammonium hydroxide (TMAH) or an aqueous solution of trimethyl-2-hydroxyethylammonium hydroxide.

9. A filter device comprising:
a filter having a first through-hole that has a first opening and a second opening, and extends in a first direction; and
a support unit that has a first portion and a second portion, the first portion having a second through-hole with a third opening and a fourth opening and extending in a second direction, and the second portion connected to the first portion in a vicinity of the third opening to support the filter.

10. A filter system comprising:
a storage tank storing a liquid including a liquid-in defect;
the filter device according to claim 1;
a liquid delivery pump that is connected to the storage tank and the first port of the filter device, and liquid-delivers the liquid to the filter device from the storage tank; and
an evaluation device that is connected to the second port of the filter device and the storage tank, and measures the liquid-in defect.
